(19) United States
(12) Patent Application Publication
(10) Pub. No.: US 2005/0213041 A1
(43) Pub. Date: Sep. 29, 2005

(54) System and method for animation

(76) Inventor: Richard Schmelzer, Boulder, CO (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/914,518

(22) Filed: Aug. 9, 2004

Related U.S. Application Data
(60) Provisional application No. 60/557,188, filed on Mar. 29, 2004.

(51) Int. Cl. G03B 21/32

(52) U.S. Cl. 352/87

(57) ABSTRACT

A system and method for controlling the display of objects is described. One embodiment of the present invention includes a transport mechanism for moving objects, an illumination source that illuminates the objects at a frequency and duration; and a control system for controlling the speed of the transport mechanism and calculating the illumination frequency and duration.

### PRIORITY

The present application claims priority from to commonly owned and assigned application No. 60/557,188 entitled Method and Apparatus for Image Projection, which is incorporated herein by reference.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to systems and methods for image management. In particular, but not by way of limitation, the present invention relates to systems and methods for managing and presenting images of two or three dimensional objects.

### BACKGROUND OF THE INVENTION

Devices for animating sequences of inanimate objects have existed for more than a century. For example, William Homer developed a device called a zoetrope in 1834. This device used vertical view slits opposite a set of images on a spinning platform to exploit the human eye's perception of motion to create the illusion that the images inside the device were animated.

With the development of electric motors, zoetropes evolved from manually powered devices to motorized devices. The basic concept of the zoetrope, however, has not evolved much beyond the introduction of a motor.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

Embodiments of the present invention can provide a system and method for controlling the display of images of objects. For example, one embodiment of the present invention includes a transport mechanism for moving objects, an illumination source and/or filter that illuminates the objects at a frequency and duration; and a control system for calculating this frequency and duration information.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram of one embodiment of the present invention;

FIG. 2 is a diagram of one embodiment of an image display system that uses a belt to move objects through the viewing areas;

FIG. 3 is a diagram of one embodiment of an image display system that uses a rotating platform to move objects through a viewing area;

FIG. 4 is a diagram of one embodiment of an illumination source using a combination of constant lighting and the control of an LCD (Liquid Crystal Display) to produce a shuttering effect;

FIG. 5 is a flowchart of one method for visually pausing the animation(s);

FIG. 6 is a flowchart of one method for managing the sequence of displayed images; and

FIG. 7 is a method for generating objects that can be viewed.

### DETAILED DESCRIPTION

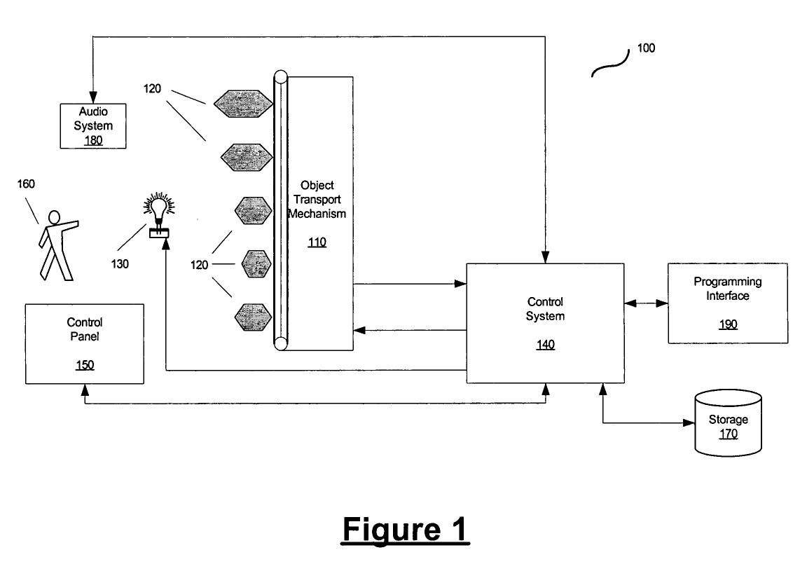

Referring now to the drawings, where like or similar elements are designated with identical reference numerals throughout the several views, and referring in particular to FIG. 1, it illustrates a block diagram of an image display system constructed in accordance with embodiments of the present invention. This system comprises an object transport mechanism 110 that moves objects 120 whose images are to be displayed. The objects 120 are illuminated by the illumination source 130, which can be controlled by the control system 140.

The control system 140 can also control the operation of the transport system 110. The control system 140 can be operated from the operations panel 150 and can make control decisions based on timing, position, and/or speed data received, for example, from the transport system 110. In some embodiments, the control system 140 may present a programming interface 190 for use in programming the system. The programming interface 190 may be used to configure the system with information regarding object positioning, animation sequence properties and any other information needed to operate the animation displays.

In some embodiments, the illumination source can consist of simply a free-standing light source. In other embodiments, the illumination source can consist of a light source and a light source controller. In some embodiments, the illumination source can consist of a light source and a light filter such as a shuttering device, which can alternately block and unblock the light source.

The spectator 160 views the objects 120 and uses the operations panel 150 to determine how the images will appear. An illumination source 130 can be provided at each viewing station (not shown). The viewing station(s) generally include components to control the illumination of the objects as they pass. Typically, the viewing station includes components to allow or cause light to strike the objects in a strobing fashion. These components are discussed in more detail below.

This strobe-like method of illumination uses the limitation of human perception known as “persistence of vision” to establish the perception of animation at each viewing station by illuminating all or a subset of objects 120 as they traverse the viewing station. Each object 120 is typically illuminated for very short periods of time to ensure crisp images and general visual quality. Depending upon the speed at which the objects 120 pass the viewing station, objects are illuminated for between approximately 20 to 1000 microseconds, though this will further depend on characteristics of the objects, the visual requirements of the display, and as needed for image quality. The visual quality of the display is highly dependent on the “aperture” (the duration of the strobe) of the illumination source 130. If the speed of the transport 110 must be changed, the aperture will normally also need to be changed in order to eliminate blurring. Embodiments of the present invention have the ability to vary the aperture based on parameters like transport speed. This is useful for providing visual effects like pauses that typically require a substantial increase of the transport's 110 speed and thus a decrease in the aperture of the flash of illumination.

An example of the use of the system would be to display an animation of Elvis Presley's rock and roll dance moves. In this example, a serpentine belt could be used as an object transport system. A number of figures, each of Elvis in a slightly different pose of the movement, would be mounted along the transport mechanism's belt. Once the spectator 160 started the display using the control panel 150 and once the transport 110 was moving the objects 120 past the viewing station at an appropriate speed, the control system 140 could flash the illumination source 130 at a corresponding rate. This would (much like a movie projector) cause the briefly illuminated images of Elvis to combine together in the spectator's vision so that Elvis appeared to be dancing.

And in one embodiment, the control system 140 could also be linked to an audio system 180 that played music or a sound track in synchronization with the movement of illuminated objects. The synchronization information could be imbedded by commercially-available software such as iDVD and/or iMovie, both made by Apple Computer, Inc., possibly in conjunction with the use of the MIDI (Musical Instrument Digital, Interface) or SMPTE (Society of Motion Picture Technicians and Engineers) time-coding standards. The sound track or the control system 140 could generate the synchronization information (click track) based on the time position of the sound track or the audio information of the sound track.

Still referring to FIG. 1, the control system 140 can control timing of the illumination of objects 120 based on (among other things) information concerning the absolute or relative position of the transport mechanism 110, positioning of objects 120 in the transport 110, direction and/or speed of movement of the objects 120 or transport 110, and the location of the viewing stations with respect to the transport 110. For example, the control system 140 can base the rate of illumination on the speed of the object's 120 travel, strobing the objects 120 as each one passes the same point within the viewing station to make the objects 120 appear animated. In another example, the control system 140 can delay in turning on the illumination 130 until the objects 120 have reached a suitable speed. In an additional example, the control system 140 could increase or decrease the speed of the animation by modifying the speed of the transport 110 using control input from the operations panel 150. The control system 140 could also increase or decrease the aperture of the illumination.

The control system 140 can also provide the ability to produce slow-motion animation by slowing the transport mechanism 110 so that there is a greater period of time between the illumination of objects in the sequence. The visual quality of the animation at low transport speeds may be enhanced by including duplicate objects placed in succession or intermittently in an animation sequence and illuminating each duplicate to maintain the persistence of vision without the need to increase the transport speed. To provide this type of illumination, the control system 140 may be aware of which figure is at which position in the transport mechanism 110. The control system 140 may also be aware of which objects 120 are duplicates. This type of object position information can be stored in a storage device 170 connected to the control system 140.

The control system 140 can also provide the ability to display reverse animation by illuminating the objects 120 in reverse order. Additionally, the control system 140 can allow multiple animations to be visually interposed by illuminating objects 120 from two or more different animation sequences. A similar effect may be achieved by illuminating objects 120 within a single animation sequence multiple times in rapid succession as they pass the viewing area so as to create the illusion of multiple replicas of the same animation for the viewer. This interposing capability may also be used for “ghosting” effects where two objects appear to occupy the same space. Ghosting effects are created by illuminating two or more different animation sequences so that the objects in those sequences are all illuminated as they pass at or near the same point in the viewing area.

The interposing capability may also be used to create the illusion of a single animation consisting of multiple objects by illuminating two or more different animations while shifting the timing of the illumination between the animations so that one animated object appears near but separate from another animated object in the viewing area. For example, if objects representing animation frames (“cells”) of two different dancers are illuminated, and the first animation's objects are illuminated slightly earlier as they move through the viewing area than the second animation, the effect of two dancers dancing with the other may be created. Cells are defined as a single step or frame of movement of an animation sequence. Each cell is represented and embodied by at least one three dimensional object in the transport mechanism. To create this effect of two dancers dancing with the other, the programmer would select the desired animations for display at the spectator's viewing station. Information regarding the visual separation distance could be selected by the programmer through the control panel 150 or predetermined by the control system 140. The time offset used between illuminating each animation's objects 120 may be calculated from the desired separation distance and the speed of the transport 110.

An animated object can be made to appear as if it were moving across the viewing area by illuminating each object slightly before or after the point in space where the previous object was illuminated. For example, a walking figure could be made to appear to move across the viewing area by illuminating the figures at a frequency just slightly slower than the frequency at which the objects pass the viewing station. To create this effect, the speed the object would appear to move would be selected by the spectator through the control panel 150 or determined by a property of the animation sequence that is preprogrammed in the control system 140. The required illumination frequency shift is determined by the desired speed of object's perceived movement and the transport speed. For displays where the objects must appear to move across distances greater than the area effectively illuminated by a single light source, this effect may be created by moving the location of the illumination source itself instead of (or in conjunction with) changing the illumination frequency.

The control system 140 may also provide the ability to blur or visually smear the animation by extending the length of time for which the object is illuminated. This technique allows the viewer's eyes to perceive more of the actual movement of the object instead of just freezing each cell of the animation by using shorter illumination periods. This effect is accomplished by having the spectator select an illumination time longer than the typical maximum of a particular transport speed. The longer the time of illumination, the stronger the blurring effect.

The control system 140 may also provide a capability to identify an element of an animation sequence that has been visually “paused” in order to determine which particular object (of the many that are traversing the viewing area) is of interest. This could be useful for identifying an element of a sequence that has a visual problem in object shape or animation. Since the control system 140 receives information on both speed and position of objects, any time a spectator pushes a control to pause the animation, the control system 140 can determine which object was being viewed by the spectator at the time the pause was selected. This is accomplished by determining how far the transport 110 had moved with respect to a known point on the transport 110 when the pause button was pushed along with information about which object is mounted to the transport in that position. The control system 140 may also allow the selected paused animation cell to be reselected on a frame-by-frame basis so that the spectator can step through each frame of the sequence.

The control system's 140 synchronization with the transport mechanism 110 can optionally allow viewing of the objects as the movement of the transport 110 is brought up to speed or as the transport is brought to a stop, since the illumination rate may be decreased or increased by the control system 140 as needed to illuminate the objects 120 so that they appear animated within the viewing station.

In one embodiment, the control system 140 may be implemented as a state machine using small-scale logic. In another embodiment, the control system 140 may be implemented as a processor-controlled system or controlled by a home computer.

In certain embodiments, the illumination control system 140 can provide input or output capabilities to allow for synchronization with audio sources 180. This synchronization can be used, for example, so that each viewing station has a separate audio track synchronized with the animation being viewed at that station. For example, as Elvis sings different words on an audio track, he would move in unison with the song. If the control system 140 is providing an output, it can use the trigger event, possibly delayed by one or more additional trigger events if the selected program requires multiple cycles of the transport to complete, as the “start” signal for the audio. If the control system 140 is accepting an output it can begin the illumination of an animation when the audio system sends a signal denoting the beginning of the audio sequence. Trigger events are discussed in detail below.

The objects 120 are mounted to the transport mechanism 110 so as to position each object accurately with respect to some fixed point on the object 120 and so that each object 120 is positioned relative to a timing position on the transport mechanism 110 thus allowing for precise animation. The mounting technique may allow the objects 120 to be easily unmounted and/or replaced. The objects 120 may be part of the transport mechanism 110 itself. Typically, the objects 120 will comprise different incremental steps of movement in the animation. The mounting and transport 110 may be shaped and/or colored as to be inconspicuous in comparison to the objects 120. The mounting system may allow the mounting of articulated figures (such as toy figures and dolls) or other malleable objects to the transport mechanism 110.

The objects 120 can comprise incremental steps in movement (cells) of more than one animation sequence. For example, if A and B are two different animation sequences, each with an animation sequence 1 . . . n, the objects affixed to the transport can be arranged as A1, B1, A2, B2 . . . An, Bn. By illuminating every other object at an appropriate speed, a spectator at a viewing station may elect to see either the A or the B sequence by itself, since only the selected sequence is illuminated. Those skilled in the art will recognize that numerous variations and substitutions in object placement and illumination patterns may be made in the invention to enable different visual effects.

The speed of the transport 110 is variable and controllable to ensure viewing quality, which can be useful in situations in which object elements of an animation sequence may be interposed with objects from a different animation sequence or for other purposes. The ability for the control system 140 to vary the speed of the transport 110 is important because an insufficient rate of illumination of the objects 120 can result in a degraded perception of animation. Thus when viewing sequences of objects where there are few objects of interest on the transport relative to the number of other objects, the speed of the transport 110 may need to be increased to illuminate the objects frequently enough for visual quality. Likewise, when there are many, closely packed objects, the transport speed may be reduced to avoid the animation proceeding too quickly. The transport speed is controlled using a combination of programmer input and/or default rules programmed into the control system 140. Rules can determine what ranges of speed will result in appropriate visual quality and may be used to determine when illumination of duplicate objects is needed.

Spectator-controlled programs, consisting of an ordered sequence of selected smaller sequences of animation which are appended together, may be created and optionally stored by the control system 140. For example, a system containing objects representing cells of animation sequences for three different dance movements could be use to present up to six different three-movement animations by illuminating the objects to effectively combine the individual dance moves into one longer sequence of moves. Once a particular combination of subsequences is selected, this animation program can be identified and stored for later playback. In this example of a three-movement animation, the objects associated with the first sub-sequence would be illuminated in order, followed by the objects in the subsequent sequences. In one embodiment, the control system 140 could select and insert particular sequence-pair-specific transition objects into the presentation sequence to more smoothly transition the smaller sequences into larger animations.

The operations panel 150, in conjunction with the control system 140, allows the spectator to start/stop the display, change lighting levels and transport speed, select animation sequences, control visual features such as pause/slow-motion and fast-forward, and to select, control, program and/or store combinations of sequences of animations. The panel 150 can also be used to change the illumination duration and to shift the illumination's timing to adjust where the image, which could be two or three dimensional, will appear in the viewing area. Once an object is visually paused, the panel can be used to display identification of the currently-selected object and to reselect other objects to be paused much like a video player's “jog” controls.

In an alternative embodiment, the objects 120 may be non-static to enable a wider range of animation than could be accomplished with a finite number of static objects. The movement of the static objects may be controllable without stopping the transport mechanism 110 by using wireless control or by using control signals that connect the control panel 150 to the objects through the transport mechanism.

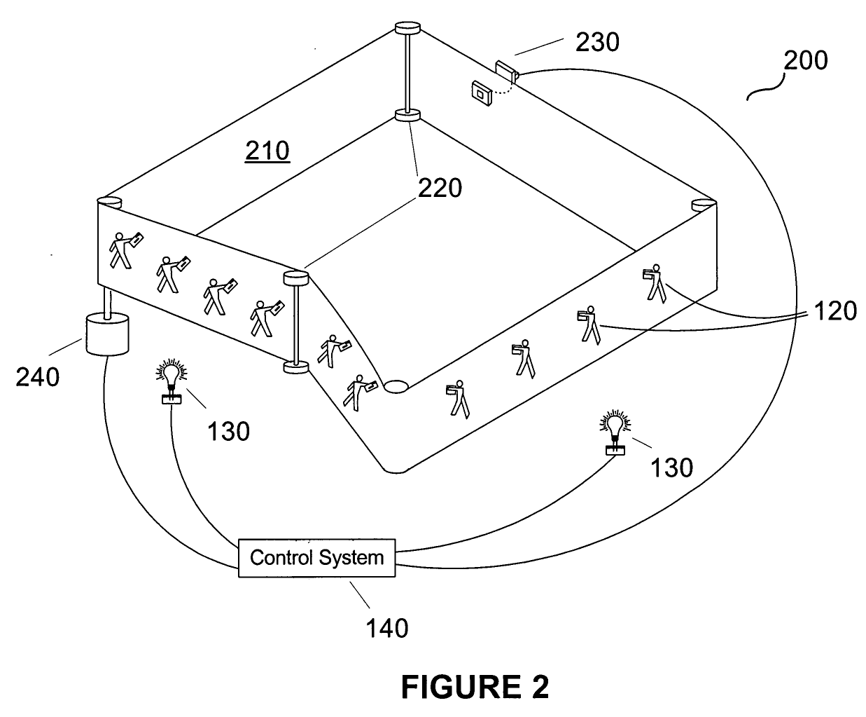

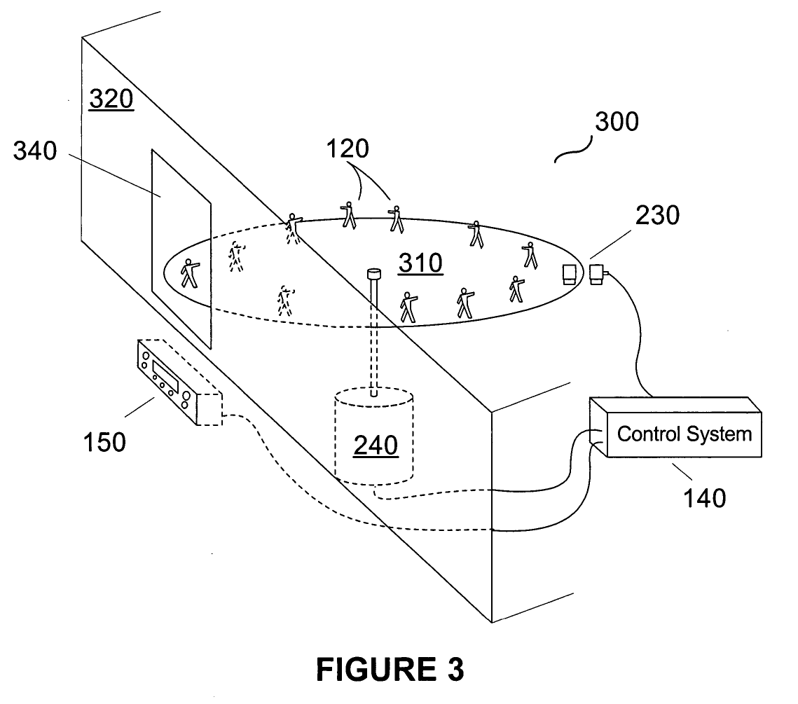

For example, in one embodiment of the present invention, a triggering mechanism is used to send information about the speed and position of the transport mechanism 110 to the control system 140. Examples of typical placement of such triggers are shown in FIG. 2, Element 230 and in FIG. 3, Element 330. In one embodiment, the trigger is a laser trigger. In another embodiment, the trigger is a Hall effect device with the fixed element of the device attached to a position external to the transport mechanism and the device's moving element attached to the transport mechanism so that the trigger event can disclose both the rate of movement as well as where the transport and its objects are in space. The trigger mechanism sends a signal to the control system 140 when the trigger senses the moving element of the trigger pass near the fixed element. Information about the distance between the trigger's moving element and each object (d_{object)} combined with the speed of the transport allows the controller to determine where each object will be at any given period of time. The transport's speed, t_{S}, is determined by its length divided by the time between trigger events. When the transport operates at a constant speed, an object will pass by a viewing station at a fixed time, t_{object}, after the trigger event, where this time is d_{object}/tₛ. Thus the control system 140 can create the desired animation by turning on the illumination source 130 for each object for a short duration every t_{object} time-units after the trigger event.

Although the trigger's moving element can be positioned on one or more of the objects (or the trigger can be the object itself), positioning it on the transport 110 as some embodiments do allows the illumination synchronization to occur independently of the positions of the objects 120 themselves. Although one embodiment can use a light-beam-break trigger method based on the passage of the objects 120 themselves, this limits the shapes of the objects (since irregular shapes would “break” the beam at different times, resulting in shaking, not smooth animation). By positioning the trigger on the transport, more sophisticated animation effects may be achieved, since trigger events that occurred for every object's traversal of the trigger area can thereby disclose the position of the transport itself within its path of traversal. Effects like visually pausing the animation generally require the knowledge of where and when a particular object will pass the viewer which is difficult without some method of discovering where the object exists within the transport mechanism's path.

In one embodiment the control system 140 may store the identity and/or location of each object as it passes some point in space. Using this information, the control system 140 can correct itself, possibly overcoming any slippage of the drive mechanism of the transport 110. This information can also be used to help the control system know where the transport mechanism 110 came to rest when it last stopped, allowing it to understand where the objects are when the transport is restarted.

In one embodiment the control system 140 may provide a “Gallery Mode” which allows the display to run unattended by continuously running the display for a period of time, turning the display off for another period of time, and then turning it back on and so on until the gallery mode is stopped.

Referring now to FIG. 2, it is one possible embodiment of the transport mechanism 200 where the mechanism comprises a flexible belt 210 that moves cyclically through a series of guides 220 and a drive system 240. In another possible embodiment of the transport mechanism 200, the mechanism comprises a flexible chain or chains that move cyclically through a series of gears or chain-guides. In some embodiments, a speed and/or position sensor 230 attached to the transport can provide information for the control system 140.

The illumination source 130 could be one or more LEDs, possibly focused through one or more lenses or light filters. Using LEDs as an illumination source 130 is advantageous because of their high switching speed, low cost, long life, and safe low-voltage operation. One such LED is the Luxeon Star, White, Lambertian, LXHL-MW1D model from LED Supply in Rochester, Vt.

Depending on the type of illumination source 130 used, the source may be positioned in close proximity to the objects, or at some (possibly large) distance away.

Referring now to FIG. 3, it is one possible embodiment of the transport mechanism 300 where the mechanism comprises a rotating disk 310 on which the objects 120 are mounted on the surface or edge of the disk. This embodiment could be mounted behind a wall or screen 320 containing a view port 340, thereby keeping the rest of the mechanism hidden from view. It is another possible embodiment where the rotating disk is positioned independently without a wall or screen between the disk and the spectator.

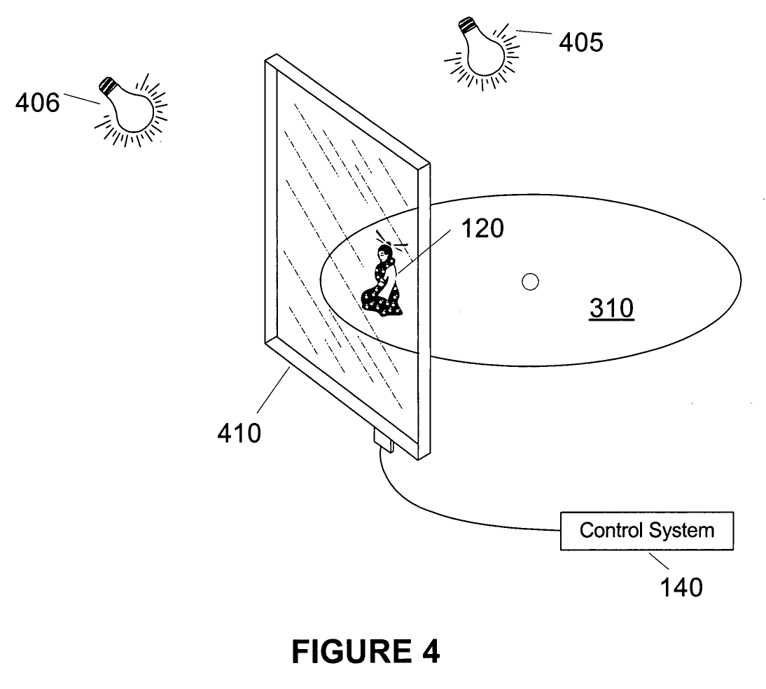

Referring now to FIG. 4, it is one possible embodiment of an illumination system, where the source of light is an internal 405 and/or external (including ambient) 406 light and where a shuttering device such as an LCD 410 is used to control visual access to the object 120 in the viewing area in order to repeatedly block the illumination (or to block line of sight to the objects) at the frequency needed to create the animation effect. One such type of LCD uses Polymer Dispersed Liquid Crystal or PDLC technology to allow rapid switching between opaque and transparent modes. An exemplary PDLC device is manufactured by Boulder Nonlinear Systems located in Boulder, Color. Another type of LCD uses ferroelectric technology that is typically used for auto-darkening welding-mask applications. An exemplary device of this type is manufactured by Morsafe, located in Belmont, Mo.

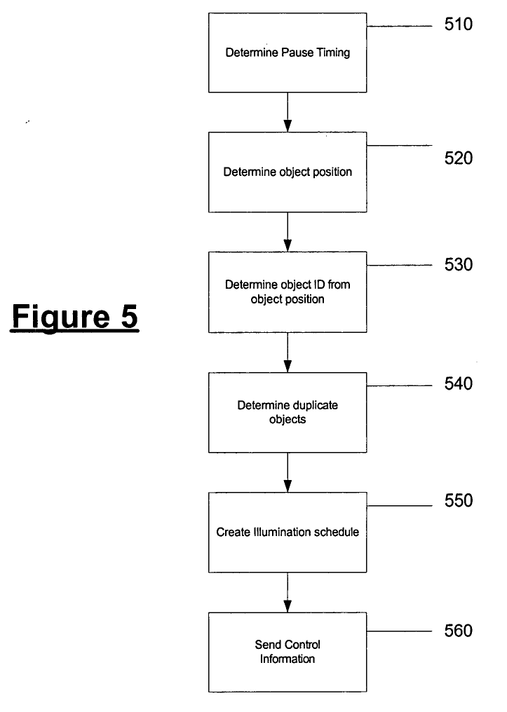

Referring to FIG. 5, it is a flowchart of one method for visually pausing the animation(s). This method begins with the user pushing a pause button at a point of interest during the animation, although the pause could also be an automated part of a program. Next, the amount of time that passed between the most recent trigger event and the time the pause occurred (either programmatically or by user control) is determined (Block 510). The speed of the transport is divided by this lag time and then divided by the object spacing to determine how many object positions the transport had moved relative to the trigger location when the pause was selected (if by user control) or by object ID(s) (if being done programmatically) (Block 520). This object position is then combined with the offset of the viewing station's location (in units of objects from the trigger location) to find which object was being viewed at the time the pause was selected (Block 530). The ID of the selected object is then determined by looking up the ID in a mapping of positions versus IDs. Alternatively, a table lookup may be performed in Block 530 to map directly from a delay lag time to an object position or ID. In some embodiments, the object ID may be synonymous with its position within the transport. This object ID can in turn be used with other configuration information to determine if there are duplicate objects on the transport (Block 540). If necessary, illuminating multiple copies of the same object within the transport mechanism can be done to provide an illumination frequency of sufficient speed to create the illusion of a stationary image of the object. Finally, the transport speed and position information of the object(s) and distance of the viewing station from the fixed trigger location are used to compute the time or times, tₚₐᵤₛₑ₍ₙ₎ the objects will pass the viewing station as an offset from the trigger event (Block 550). Finally, the controller will then signal for the illumination of the object(s) every tₚₐᵤₛₑ₍ₙ₎ seconds after the subsequent trigger events are detected (Block 560).

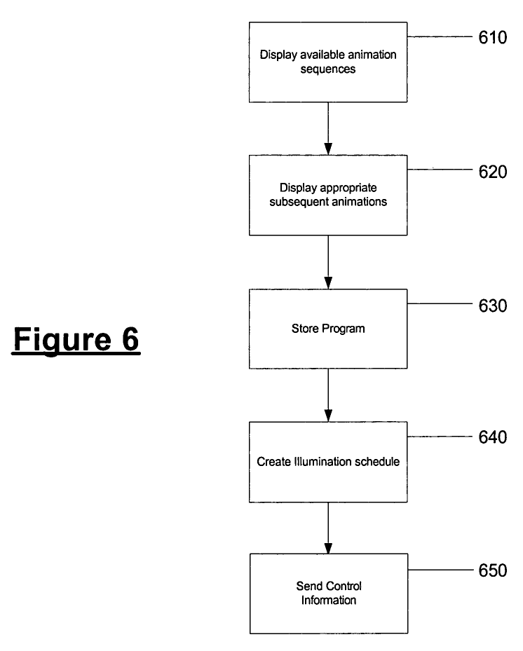

Referring to FIG. 6, it is a flowchart of one method for managing the sequence of displayed images. The method begins with the user choosing to create a new program. Next, the user is allowed to choose a first animation from a list of animation sequences available (Block 610). The available sequences are based on which objects are on the transport. This information would already have been obtained by the controller 140 from the programming interface 190. The user may then select additional animations, where the selection may be limited to sequences that are visually compatible with the previously selected animation sequence(s) (Block 620). Next, a list of object IDs (which may span more than one complete cycle of the transport) is assembled and this list is stored as an animation program using the Program Identifier given by the user as a key for later lookup (Block 630). Alternatively, the list of animation sequences may be used to represent the stored program instead of the object IDs. A mapping of object IDs is then used to determine a sequence of time offsets that denote when the objects should be illuminated with respect to the trigger event (Block 640). Because a program may consist of multiple animation sequences, and because the transport 110 may have to complete at least one cycle to display a single animation sequence, this schedule of time offsets may span several trigger events. Finally, the resulting sequence of illumination signals are sent to the illumination source (Block 650).

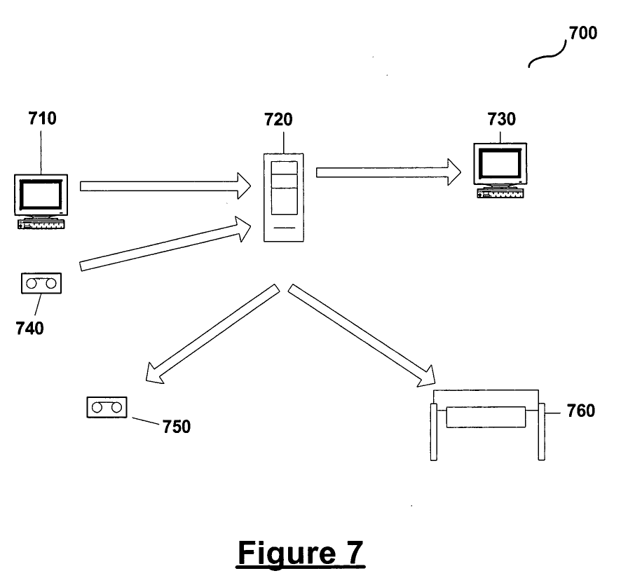

Referring now to FIG. 7, it illustrates a system 700 for designing viewable objects. An input interface 710 is used to design objects and animations using commercially available computer-aided design and animation software and hardware 720. Commercially-available audio processing software, possibly collocated on the platform running the CAD and/or animation software, may also be used to synchronize an audio soundtrack 740 to the animation. Exemplary software systems for these purposes include Maya (for animation) made by Alias Systems Corp., iMovie (for general movie-making) and iDVD for audio processing, both from Apple Computer, Inc. A simulation 730 of how the animation will appear when the specified objects are used within the image display invention may be viewed by a spectator of this system. The final output of the design system is a set of object and animation specifications which are capable of being sent to an object fabricator 760 and (optionally) an audio soundtrack 750 suitable for synchronizing with the created animation.

Objects for use with system 700 may be created in conjunction with an automated object fabrication capability. An exemplary fabrication system is the “ZPrinter 310” made by Z-Corporation in Boston, Mass. The resulting system provides a rapid-production capability for three-dimensional animation. The fabrication capability could in turn be used in conjunction with an animation simulator. The animation simulation can be used to preview the visual presentation that a spectator would perceive at a viewing station, including simulating how the results of visual control features like motion pauses will appear, taking into account transport speed, illumination, object placement and possible object repetition, among other things. The simulation could help identify problems with the animation prior to the fabrication of the objects.

In conclusion, the present invention provides, among other things, a system and method for displaying animations of two or three-dimensional objects. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

1. A method for controlling the display of three-dimensional objects that are movable within a path and illuminatable by an illumination source, the method comprising:
receiving information about the position of at least one of the three-dimensional objects within the path;
receiving information about the speed that the at least one of the three-dimensional objects is traveling within the path;
using the received information about the position and the received information about the speed, calculating an illumination frequency for the illumination source;
using the received information about the position and the received information about the speed to calculate an illumination duration for the illumination source; and
providing a control signal to the illumination source, the control signal corresponding to the illumination frequency information and the illumination duration information;
whereby the control signal is usable to control the behavior of the illumination source and thereby establish the perception of animation of the three-dimensional objects.

2. The method of claim 1, wherein the receiving information about the position of at least one of the three-dimensional objects within the path comprises:
receiving information about the orientation of a transport mechanism used to move the three-dimensional objects.

3. The method of claim 1, wherein the receiving information about the position of at least one of the three-dimensional objects within the path comprises:
receiving positional information from a trigger mechanism.

4. The method of claim 3, wherein the positional information comprises:
an indication of when at least one of the three-dimensional objects moves past a fixed point along the path.

5. The method of claim 1, wherein the receiving information about the position of at least one of the three-dimensional objects within the path comprises:
receiving information about the position of the at least one of the three-dimensional objects relative to a fixed point along the path.

6. The method of claim 1, wherein the receiving information about the position of at least one of the three-dimensional objects comprises:
receiving the identity of the at least one three-dimensional object as it moves past a point within the path.

7. The method of claim 6, further comprising:
storing information about the position and the identity of the at least one of the three-dimensional objects;
wherein the stored information is usable to determine the control signal.

8. The method of claim 1, wherein the receiving information about the speed that the at least one of the three-dimensional objects is traveling within the path comprises:
receiving information about the speed of the at least one of the three-dimensional objects relative to a fixed point in the path.

9. The method of claim 1, wherein the receiving information about the speed comprises:
receiving information about the speed of a transport mechanism used to move the three-dimensional objects.

10. The method of claim 1 further comprising:
calculating a new speed of movement from the received information; and
providing a control signal to the transport mechanism used to move the three-dimensional objects, the control signal corresponding to the new speed of movement;
whereby this calculated, new speed is usable to create an animation effect with the three-dimensional objects.

11. The method of claim 1, wherein calculating the illumination frequency comprises:
calculating the illumination frequency using at least one of object positioning, animation sequence properties, duplicate object positioning, information to enable ghosting, animation program selection, viewing location, or object movement information.

12. The method of claim 1, wherein calculating the illumination duration comprises:
calculating the illumination duration using at least one of object positioning, animation sequence properties, duplicate object positioning, information to enable ghosting, animation program selection, viewing location, or object movement information.

13. The method of claim 1, wherein the providing a control signal to the illumination source comprises:
causing the illumination source to switch on and off.

14. The method of claim 1 further comprising:
calculating audio timing information from the received information about the speed and position of the at least one of the three-dimensional objects;
and sending a control signal to an audio source, the control signal corresponding to the calculated audio timing information.

15. The method of claim 1 further comprising:
receiving audio timing control information; and
calculating the control signal using the audio timing control information.

16. The method of claim 1, further comprising:
receiving an instruction to control the display; and
calculating the control signal at least in part based upon the received instruction.

17. The method of claim 16, wherein the instruction is provided by a pre-programmed sequence of instructions.

18. The method of claim 16, wherein the instruction contains information regarding at least one of object positioning, animation sequence properties, duplicate object positioning, information to enable ghosting, animation program selection, viewing location, or object movement information.

19. The method of claim 16, wherein the instruction comprises a slow-motion animation instruction.

20. The method of claim 16, wherein the instruction comprises a fast-forward animation instruction.

21. The method of claim 16, wherein the instruction comprises a reverse animation instruction.

22. The method of claim 16, wherein the instruction comprises a pause instruction.

23. The method of claim 22, wherein at least one three-dimensional object is illuminated at a frequency sufficient to create the illusion of a stationary image of the three-dimensional object.

24. The method of claim 23 further comprising:
identifying which object is currently paused in the animation.

25. The method of claim 16, wherein the instruction comprises a gallery-mode instruction.

26. The method of claim 16, wherein the instruction is to create a spectator-controlled animation program.

27. A system for controlling the display of images of a plurality of objects that are movable in a path and illuminatable by an illumination source, the system comprising:
a processor;
a memory device connected to the processor; and
a plurality of instructions stored on the memory device, the plurality of instructions configured to cause the processor to:
receive information about the speed of at least one of the plurality of objects;
calculate at least one control instruction for the illumination source using the received information; and
provide the at least one control instructions to the illumination source;
whereby the control instruction is usable to control the behavior of the illumination source and thereby establish the perception of animation of the objects.

28. The system of claim 27, further comprising:
an object transport mechanism; and
an illumination source to illuminate objects moved by the transport mechanism wherein the illumination source is controllable by the processor.

29. The system of claim 28, wherein the object transport mechanism is capable of multiple speeds, wherein the object transport mechanism is controllable by the processor.

30. The system of claim 28, wherein the illumination source comprises:
an LCD.

31. The system of 30, wherein the LCD has an associated variable opacity that is controllable as a shutter to provide animation effects when used with a source of light.

32. The system of claim 28, wherein the illumination source comprises:
at least one LED.

33. The system of claim 28, wherein the transport mechanism comprises:
a rotating substrate to which the three-dimensional objects can be affixed.

34. The system of claim 28, wherein the transport mechanism comprises:
a moving belt or a moving chain.

35. The system of claim 28, wherein the control instruction is usable to control the duration of the illumination source.

36. The system of claim 28, wherein the control instruction is usable to control an audio system.

37. The system of claim 28, wherein the object transport mechanism comprises:
an object coupler, wherein the coupler is configured to allow the mounting and unmounting of articulated figures or other malleable objects.

38. The system of claim 28, wherein the plurality of objects are created using computer-aided animation software.

39. The system of claim 28, wherein the plurality of objects are created using an automated object fabrication capability.

40. The method of claim 28, further comprising a storage device configurable to store information about duplicate animation objects.

41. A system for displaying three-dimensional objects, the system comprising:
an object transport mechanism configured to move the three-dimensional objects;
an illumination source configured to illuminate the three-dimensional objects moved by the transport mechanism; and
a control system configured to control the illumination source.

42. The system of claim 41, wherein the control system is configured to control the illumination source using information regarding the speed of the transport mechanism.

43. The system of claim 41, wherein the control system is configured to control the illumination source using information regarding the location of at least one of the three-dimensional objects.

44. The system of claim 41, wherein the control system is configured to control the duration of the illumination source.

45. The system of claim 41, wherein the transport mechanism is configured to operate at two speeds and, wherein the control system is configured to vary the speed of the transport mechanism between the two speeds.

46. The system of claim 41 further comprising:
an audio source configured to play a soundtrack synchronized with the animation display.

47. The system of claim 41 further comprising:
a storage device configured to store configuration information for use by the control system; the configuration information comprising at least one of:
object positioning, animation sequence properties, duplicate object positioning, information to enable ghosting, animation program selection, viewing location, or object movement information.

48. A method for controlling the display of movable objects that are illuminatable by an illumination source, the method comprising:
calculating an illumination frequency for the illumination source; and
controlling the illumination source based on the calculated illumination frequency.

49. The method of claim 48, wherein the movable objects are two-dimensional.

50. The method of claim 48, further comprising calculating an illumination duration for the illumination source and controlling the illumination source based on the calculated illumination duration and illumination frequency.

51. A method for controlling the display of movable objects that are illuminatable by an illumination source, the method comprising:
calculating at least one of an illumination frequency and an illumination duration for the illumination source; and
controlling the illumination source based on at least one of the calculated illumination duration and the calculated illumination frequency.
